(19) United States
(12) Patent Application Publication
(10) Pub. No.: US 2018/0018894 A1
(43) Pub. Date: Jan. 18, 2018

(54) SOCIAL INTERACTION DURING ONLINE AND BROADCAST LIVE EVENTS

(71) Applicant: John Lawrence Coulson, SR., Pender Island (CA)

(72) Inventor: John Lawrence Coulson, SR., Pender Island (CA)

(21) Appl. No.: 15/348,694

(22) Filed: Nov. 10, 2016

Related U.S. Application Data
(60) Provisional application No. 62/256,572, filed on Nov. 17, 2015.

(51) Int. Cl. G09B 9/00; G09B 9/04; A63F 13/46; A63F 13/25; A63F 13/215; G09B 9/08; A63F 13/213

(52) U.S. Cl. CPC G09B 9/00; G09B 9/08; G09B 9/04; A63F 13/213; A63F 13/25; A63F 13/215; A63F 13/46

(57) ABSTRACT

Technology is described for enabling social interaction during online and broadcast live events for the main purposes of online video style game playing for entertainment and education and to act as an interactive and fully immersive online educational training tool that is intended for fun while learning that could result in potential profit for some. In some examples, the technology can include receiving from a remote device a movement signal indicating an actual movement of a real live entertainment and/or educational professional and/or amateur person and/or other living being and/or tool(s) during real real-time live action entertainment and educational events in which the real live entertainment and/or educational professional and/or amateur person and/or other living being and/or tool(s) is participating; receiving from a local control device a control signal from a user, wherein the control signal indicates input to a hybrid simulation; comparing the received movement signal with the received control signal; computing based on the comparison a score and/or a credit to award to the user; and awarding the computed score and/or credit to the user and to stream live user created video and holographic projections and interject this live hybrid broadcast stream into the live environment occupied by real live entertainment and/or educational professional and/or amateur person and/or other living being and/or tool(s) for the purposes of entertainment, education and potential profit.

### CROSS-REFERENCE TO RELATED APPLICATION

THIS APPLICATION IS A U.S. NATIONAL STAGE APPLICATION FILING UNDER 35 U.S.C. 111(A) OF USPTO APPLICATION NO. US 62/256,572 FILED ON NOV. 17, 2015, ENTITLED SIDOBLE—SOCIAL INTERACTION DURING ONLINE AND BROADCAST LIVE EVENTS, WHICH IS INCORPORATED HEREIN BY REFERENCE IN ITS ENTIRETY.

### BACKGROUND

People use simulators to simulate various real activities and also use them as educational fully interactive virtual reality and augmented reality training tools readying them for many occupations. As an example, but not limited to, people playing video games (also known as Apps) that simulate real entertainment and educational events and real live entertainment and/or educational professional and/or amateur person and/or other living being and/or their tool(s) in live entertainment, education and other real life events, situations and occupations. This invention integrates traditional and emerging television broadcasting methods with interactive internet based simulations that serves to create hybrid video, audio and sensory broadcasting methods to enable online participants to participate in real live real-time live action events, gaming and video game style events with a live action interactor also known as an entertainer and/or educator or as a real live entertainment and/or educational professional and/or amateur person and/or other living being and/or their tool(s). e.g., a musician, a professor, a surgeon, a pilot, an astronaut, a coach or an actor. Video game (App) players can use video game consoles and emerging related technologies that are television and internet broadcast signal send and receive capable to play various video games, e.g., music and educational video games and participate in live action real-time events as if they were there in the first person, e.g., simulate playing or acting live on stage during an actual live hybrid broadcast music concert or acting event, blast of Cape Canaveral and take a live ride through the atmosphere bound for outer-space live as it happens experiencing the live ride from the perspective of the on-board astronaut(s). Take a live space walk or simulate a live landing of a scheduled 747 Jumbo Jet all from the safety and comfort of your living room. Video games (Apps) are highly endorsed by professionals and professional organizations for myriad music and educational events, as they can simulate real professionals and real professional teams and groups that entertain and/or educate other persons. SIDOBLE transcends traditional simulations by integrating them into an interactive immersive hybrid broadcasting platform enabling amateurs and professional persons to co-exist in real-time through the playing of SIDOBLE video games (Apps).

For many people, entertaining and educating in real contexts (e.g., live or broadcast music or educational events) is a very passionate activity. So much so, that people will set aside an entire afternoon, an entire day, or even several days to watch and learn from their favorite musicians or educators as they play or teach individually or in groups.

Many people also enjoy competition. They dream about playing and competing head-to-head with professional musicians or against others who are similarly passionate. Others dream of being a musician, university professor, pilot, astronaut, global explorer, surgeon and/or trend setting environmentalist, etc.

### SUMMARY

Technology is described for enabling real-time live action social interaction during online and broadcast live events for the purpose of competitive gaming and video game style playing and while participating in specialized live global events wherever they may be staged. In various embodiments, the technology includes but is not limited to receiving from a remote device, a movement signal indicating an actual movement of a human and/or other living being and/or tool or tools. e.g.: a musical instrument, an educational tool, an automobile, an airplane, etc., that they use to assist them during a real live action entertainment or educational event in which the human or other living being and/or tool is participating; receiving from a local control device a control signal from a user, wherein the control signal indicates input to a simulation; comparing the received movement signal with the received control signal; computing based on the comparison a score and/or a credit to award to the user; and awarding the computed score to the user.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is an environmental diagram illustrating an environment in which the technology may operate in some embodiments.

FIG. 2 is an environmental diagram illustrating an environment in which the technology may operate in some embodiments.

FIG. 3 is a block diagram illustrating components employed by the technology in various embodiments.

FIG. 4 is a flow diagram illustrating a routine that the technology may invoke in various embodiments, e.g., to compute scores based on a comparison between a video game player's movements and a real live entertainment and/or educational professional and/or amateur person and/or other living being and/or their tool(s) movements.

FIG. 5 is a flow diagram illustrating a routine that the technology may invoke in various embodiments, e.g., to enable a video game player to view what real live entertainment and educational professional and amateur persons can view.

FIG. 6 is a block diagram of an illustrative embodiment of a computing device that is arranged in accordance with at least some embodiments of the present disclosure.

FIG. 7 is a flow diagram illustrating a routine the technology may invoke in various embodiments.

FIG. 8 is a flow diagram illustrating a routine the technology may invoke in various embodiments.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Technology is described for enabling real-time live action social interaction during online and broadcast live events for the purpose of competitive gaming and video game style play and while participating in specialized live global events wherever they may be staged. (“the technology”). In various embodiments, the technology enables a user (e.g., a video game player or passive user) to be virtually placed in the milieu of a real, real-time live action entertainment and educational events or other specialized live global events. The technology can enable users, e.g., video game players who are playing multiplayer video games, to interact with other users and simultaneously in real-time, real live entertainment and/or educational professional and/or amateur person and/or other living being and/or their tool(s) participating in real, real-time live action entertainment and/or educational events. Thus, the technology enables video game players to cause their “avatars” and/or real live renderings of themselves to directly interact with and/or in a competitive manner against, real live entertainment and educational professional and amateur persons in the real live entertainment and educational professional and amateur persons entertainment and/or educational events. In various embodiments, the technology can enable one or more video game players to participate using a video game console, e.g., by viewing output on a television or projection screen or virtual reality display mechanism, or holographic display mechanism and providing input via a video game controller. The technology may compare input provided by a video game player to inputs measured or observed of real live entertainment and/or educational professional and/or amateur person and/or other living being and/or their tool(s), and compute a score and/or a credit based on the comparison. The technology may then award points based on the comparison of how the video game player's inputs are to the real live entertainment and/or educational professional and/or amateur person and/or other living being and/or their tool(s) inputs. Comparisons will vary in their definition as they are dependent on the rules of each specific game that this technology is intended to be applied to. The technology can also enable the video game player to observe what the real live entertainment and/or educational professional and/or amateur person and/or other living being observes, e.g., by viewing signals from one or more image capture devices (e.g., cameras, video cameras, three-dimensional cameras, holographic projection mechanisms) situated near the real live entertainment and/or educational professional and/or amateur person and/or other living being and/or their tool(s). As an example, the technology may be used in music. In this example, one or more sensors may sense inputs of a musician (who is the real live entertainer and educator in this example), e.g., guitar, keyboard, microphone, etc.; and compare a video game player's inputs at a video game controller.

The technology may simulate various aspects of the real live entertainment and/or educational professional and/or amateur person and/or other living being and/or their tool(s) physical experience, e.g., so that the video game player can also view and indeed feel almost everything the real live entertainment and/or educational professional and/or amateur person and/or other living being does. The simulation may include one or more projection screens, video monitors, three-dimensional displays, virtual reality displays, vibration and olfactory and audio sensory devices, and/or other output devices. The technology may select various devices near the real live entertainment and/or educational professional and/or amateur person and/or other living being and/or their tool(s) from which to receive inputs for the simulation, e.g., holographic projectors, cameras, vibration detectors, motion sensors, microelectromechanical systems (MEMS), global positioning systems, Nano technologies, etc.

In various embodiments, the technology performs a method comprising: receiving from a remote device a movement signal indicating an actual movement of a real live entertainment and/or educational professional and/or amateur person and/or other living being and/or their tool(s) during a real entertainment and educational or other live event and enable participation in real live events with a real live entertainment and/or educational professional and/or amateur person and/or other living being and/or their tool(s) in which real live entertainment and/or educational professional and/or amateur person and/or other living being and/or their tool(s) is participating and of the tool (musical or surgical or teaching instrument that they use to perform their live activity); receiving from a local control device a control signal, in example but not limited to a holographic projection or recording mechanisms, artificial intelligence systems, augmented and virtual reality systems, digital and analogue systems, virtually augmented reality systems from a user, wherein the control signal indicates input to a simulation; comparing the received movement signal with the received control signal; computing based on the comparison a score and/or a credit to award to the user; and awarding the computed score and/or credit to the user. The method can further comprise comparing the awarded score and/or credit to a set of scores and/or credits awarded to other users and to the real live entertainment and/or educational professional and/or amateur person and/or other living being and/or their tool(s). The method can further comprise receiving an indication to provide a view in a specified direction; transmitting an indication of the specified direction; and receiving a video sequence wherein the video sequence is representative of a view in the specified direction in relation to the real live entertainment and/or educational professional and/or amateur person and/or other living being and/or their tool(s). The video sequence may be received from one of multiple remote video cameras located proximate or affixed to the real live entertainment and/or educational professional and/or amateur person and/or other living being and/or their tool(s). The method can further comprise receiving movement signals in three dimensions. The method can further comprise receiving control signals in at least two dimensions. The method can further comprise simulating via a motion simulator movement based on the received control signals. The method can further comprise simulating via a motion simulator movement based on the received movement signal. The method can further comprise displaying on one or more panoramic images proximate to the user a view observed by one or more cameras proximate or affixed to the real live entertainment and/or educational professional and/or amateur person and/or other living being and/or their tool(s).

In various embodiments, a video game player may sign up to play online. The video game player may select a set of entertainment or educational events to interact with and/or be measured against. As an example, the video game player may select multiple musicians. If inputs from a first of the musicians can no longer be received (e.g., because of a communications failure or the first musician is no longer playing), the technology may select a second (e.g., backup) musician. The technology may also adjust the accumulated points or scores if the second musician is selected, e.g., to account for differences in performance of the two musicians.

The technology may also adjust the accumulated points or scores based on inputs. As an example, if the video game player's inputs are nearly identical to the selected real live entertainment and/or educational professional and/or amateur person and/or other living being and/or their tool(s) inputs, additional points may be awarded. The more disparity there is between the video game player's inputs and the real live entertainment and/or educational professional and/or amateur person and/or other living being and/or their tool(s) inputs, fewer points are awarded. If the video game player makes a move that would lead to a negative outcome (e.g., a wrong answer, poor performance), points may be deducted.

During the entertainment and/or educational event, the technology can collect and broadcast inputs from real, real-time live entertainment and/or educational professional and/or amateur person and/or other living being and/or their tool(s) in nearly or actual real time. As an example, a device proximate to the real, real-time live entertainment and/or educational professional and/or amateur person and/or other living being and/or their tool(s) can collect inputs, e.g., from various sensors, cameras, etc., and broadcast the collected inputs to the simulators employed by the video game players. The simulators, in turn, may compare the inputs of the video game players to the broadcast inputs, and provide this information to a server for computation of scores, comparison of the scores with scores for other players, awarding prizes based on the scores, etc.

In various embodiments, the technology may enable players using various computing devices (e.g., full motion simulators, personal computing devices, tablet computing devices, handheld computing devices, body worn computing devices, etc.) to participate, and may adjust scores to account for the different devices. As an example, a video game player using a handheld computing device may be disadvantaged by not being able to fully view camera inputs because that player cannot anticipate upcoming changes in event conditions or venue layouts as well as a player using a full motion virtual and augmented reality simulator and projection system.

In various embodiments, spectators viewing the entertainment and educational event, live on location (fans with PDA's, I-Pod's, Tablet's, etc. in the stands) or remotely may also employ aspects of the technology without playing a video game. As an example, spectators may select various camera angles, receive vibration or olfactory simulated sensory input signals, etc., even while seated as a passive spectator at the live event or watching from a location remote to live broadcast location.

In various embodiments, the technology performs a method comprising: receiving from a remote device a movement signal indicating an actual movement of a real live entertainment and/or educational professional and/or amateur person and/or other living being and/or their tool(s) during a real entertainment and educational or other live event and enable participation in real live events with a real live entertainment and/or educational professional and/or amateur person and/or other living being and/or their tool(s) in which real live entertainment and/or educational professional and/or amateur person and/or other living being and/or their tool(s) is participating and of the tool (musical or surgical or teaching instrument that they use to perform their live activity); receiving from a local control device a control signal from a user, wherein the control signal indicates input to a simulation; comparing the received movement signal with the received control signal; computing based on the comparison a score and/or a credit to award to the user; and awarding the computed score and/or credit to the user. The method can further comprise comparing the awarded score and/or credit to a set of scores and/or credits awarded to other users and to the real live entertainment and/or educational professional and/or amateur person and/or other living being and/or their tool(s). The method can further comprise receiving an indication to provide a view in a specified direction; transmitting an indication of the specified direction; and receiving a video sequence wherein the video sequence is representative of a view in the specified direction in relation to the real live entertainment and/or educational professional and/or amateur person and/or other living being and/or their tool(s). The video sequence may be received from one of multiple remote video cameras located proximate or affixed to the real live entertainment and/or educational professional and/or amateur person and/or other living being and/or their tool(s). The method can further comprise receiving movement signals in three dimensions. The method can further comprise receiving control signals in at least two dimensions. The method can further comprise simulating via a motion simulator movement based on the received control signals. The method can further comprise simulating via a motion simulator movement based on the received movement signal. The method can further comprise displaying on one or more panoramic images proximate to the user a view observed by one or more cameras proximate or affixed to the real live entertainment and/or educational professional and/or amateur person and/or other living being and/or their tool(s).

In various embodiments, the technology includes a system, comprising: a remote system, proximate to the real live entertainment and/or educational professional and/or amateur person and/or other living being and/or their tool(s) participating in a real entertainment and/or educational event, configured to observe inputs provided by the real live entertainment and/or educational professional and/or amateur person and/or other living being and/or their tool(s) indicative of a desired movement, and/or actual movements of the real live entertainment and/or educational professional and/or amateur person and/or other living being and/or their tool(s); to receive signals from one or more cameras; to transmit indications of the observations as movement signals; and to transmit a video sequence based on the signals received from at least one of the cameras; and a local system, proximate to a user participating in a simulation of the real live entertainment and/or educational event, configured to receive inputs from the user; compare the inputs received from the user with received movement signals; and compute based on the comparison a score and/or a credit to award to the user. The system can further comprise a component configured to award the computed score to the user; an electronic game; and/or one or more microelectromechanical systems (MEMS) sensors to observe movement of the real live entertainment and/or educational professional and/or amateur person and/or other living being and/or their tool(s) in multiple directions, wherein each MEMS sensor is configured to detect movement and/or rotation in one or more or all axes. The remote system can comprise a global positioning system antenna. The remote system can comprise a laser tracking system. The remote system can comprise a radio frequency identification unit. The local system can comprise a motion simulator and/or one or more panoramic displays.

In various embodiments, the technology includes one or more computer-readable storage devices storing instructions, the instructions comprising: observing movement of a first real live entertainment and/or educational professional and/or amateur person and/or other living being and/or their tool(s) during a real live entertainment and or educational event in which the first real live entertainment and/or educational professional and/or amateur person and/or other living being and/or their tool(s) is participating; transmitting to a control device remote from the real live entertainment and or educational event a movement signal indicating the observed movement; and causing the control device to actuate a motion simulator based on the movement signal. The instructions can further comprise: receiving from the control device a signal specifying a view; identifying a camera for the specified view; receiving a signal from the identified camera; and transmitting a video sequence to the control device based on the received signal from the identified camera. The instructions can further comprise broadcasting input signals from the video game player to the location proximate of the real live entertainment and/or educational professional and/or amateur person and/or other living being and/or their tool(s). The instructions can further comprise: receiving identifications of two or more real live entertainment and/or educational professional and/or amateur person and/or other living being and/or their tool(s); if movement of the first real live entertainment and/or educational professional and/or amateur person and/or other living being and/or their tool(s) cannot be observed during the real live entertainment and educational event, selecting a second real live entertainment and/or educational professional and/or amateur person and/or other living being and/or their tool(s) during the real live entertainment and educational event; ceasing transmission of movement signals indicating observed movements of the first real live entertainment and/or educational professional and/or amateur person and/or other living being and/or their tool(s); and automatically starting transmission of movement signals indicating observed movements of the second real live entertainment and/or educational professional and/or amateur person and/or other living being and/or their tool(s).

In various embodiments, the technology includes one or more digital and/or analogue audio sound recording and playback mechanisms and olfactory and other sensory I/O (input and output devices) enabling the end user to receive live sounds and other sensory inputs from the ambient environment, e.g., the vibrations musical drum instrument from live concerts, the smell of fireworks from live celebratory events, the smell of a particular murder crime scene, the smell and sound of a jet airplane engine, the sound of a space shuttle taking off and in space.

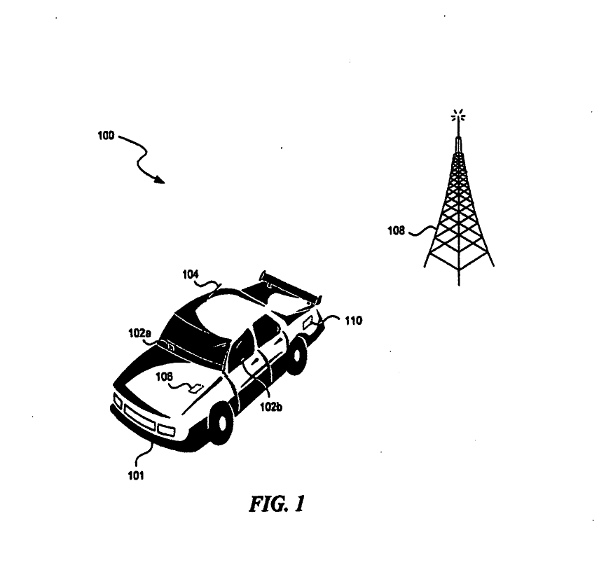

Turning now to the figures, FIG. 1 is an environmental diagram illustrating an environment 100 in which the technology may operate in some embodiments. The environment 100 can include an entertainment or teaching apparatus, e.g., a Driving instructors car 101. The entertainment or teaching apparatus can be an apparatus that an entertainer or teacher or other living being may use during a live real, real-time entertainment or educational event. Other examples of entertainment or teaching apparatuses are guitars, keyboards, microphones, surgical instruments, holographic projectors, etc., or indeed any paraphernalia electronically enabled and designed to act as an educational or entertainment tool. The car 101 can include multiple cameras and projectors including but not limited to a front camera 102a and a side camera 102b that can approximate what the real live entertainment and/or educational professional and/or amateur person and/or other living being and/or their tool(s) (e.g., a car Driving Instructor) views and/or a projector mechanism to display garners and related advertising or other visual imagery to appear proximate to the real live entertainment and/or educational professional and/or amateur person and/or other living being and/or their tool(s). Other cameras and/or projectors and/or audio recording mechanisms (e.g., rear facing, etc.) may also be employed. The car 101 may also include an antenna 104, e.g., to communicate information from the car 101 to a user's video game console (not illustrated), e.g., via an antenna 108. The car 101 may include sensors, e.g., sensors 106 and 110 to observe the real live entertainment and/or educational professional and/or amateur person and/or other living being and/or their tool(s) movements, the real live entertainment and/or educational professional and/or amateur person and/or other living being and/or their tool(s) apparatus's movements, proximity to other devices or equipment, etc. These movements and other information can be communicated to the user's video game console.

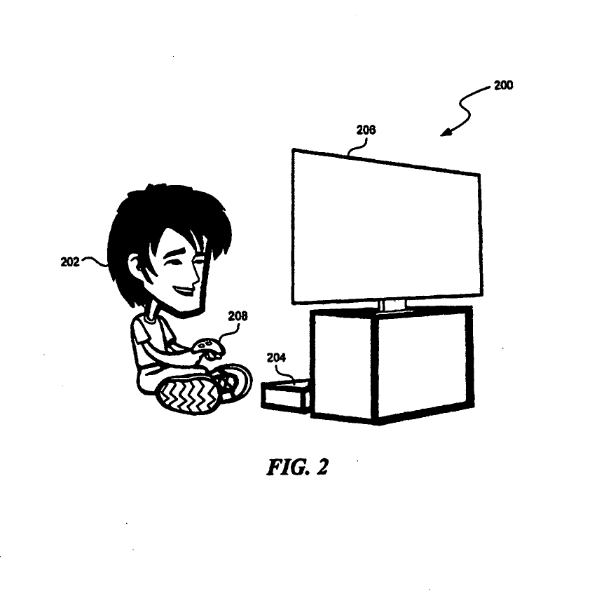

FIG. 2 is an environmental diagram illustrating an environment 200 in which the technology may operate in some embodiments. The environment 200 can include a console or set-top box 204 (e.g., a video game console), display device 206 (e.g., a projector, monitor, television, virtual and/or augmented reality display device, holographic projector, etc.) and a controller 208 (e.g., a video game controller). A user 202 (e.g., a video game player) may operate the video game controller 208 to interact with a hybrid simulation, e.g., a video game that is simulated by the console 204. The user 202 can provide input to the simulation via the controller 208, a microphone (not illustrated), or by using other input devices. Output from the hybrid simulation can be visually indicated in the display 206, provided via a tactile response on the controller 208, and/or provided aurally using speakers (not illustrated), and/or olfactory or other sensory I/O (input/output) devices (not illustrated). In various embodiments, various types of input and output can be employed. As an example, the user 202 may occupy a specially designed seat or other enclosure (not illustrated) that provides various types of simulated feedback. In various embodiments, various input and output devices may be employed. These can include keyboards, joysticks, mouse, handheld or other game controllers, balls, sticks, etc. The input devices may be general purpose or specific to a particular entertainment or educational event.

In various embodiments, the user 202 may employ a full motion simulator, surround screen (e.g., a panoramic display, virtual or augmented reality display device or H.U.D. (heads up display mechanism), etc. As an example, the full motion simulator may be in the shape of a theatrical or concert stage or surgical operating theater or an automobile or airplane.

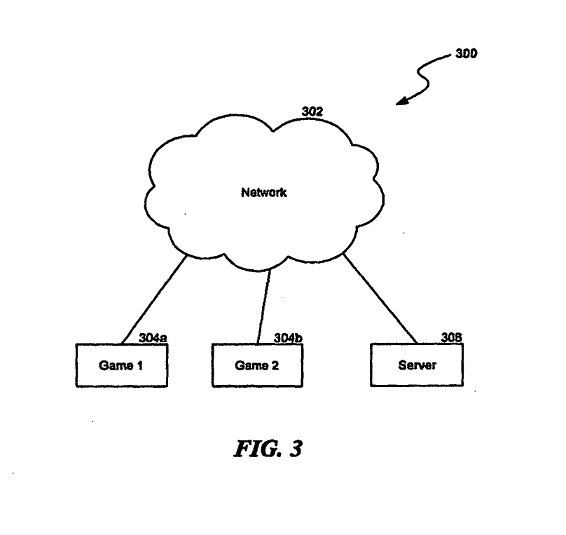

FIG. 3 is a block diagram illustrating components 300 employed by the technology in various embodiments. The components 300 can include a network 302, e.g., the Internet or an intranet, that enables one or more computing devices, e.g., a first game console 304a, a second game console 304b, and a server 306, to exchange communications with one another. As an example, the game consoles 304a and 304b may receive communications from the server 306 to indicate information collected from sensors proximate to a real live entertainment and/or educational professional and/or amateur person and/or other living being and/or their tool(s).

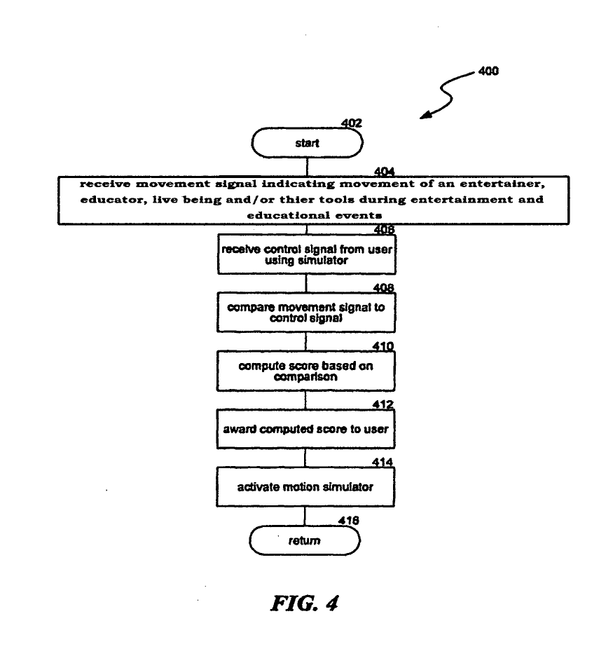

FIG. 4 is a flow diagram illustrating a routine 400 that the technology may invoke in various embodiments, e.g., to compute scores based on a comparison between a video game players movements (e.g., inputs) and a real live entertainment and/or educational professional and/or amateur person and/or other living being and/or their tool(s) movements (e.g., inputs). The routine 400 begins at block 402. The routine then continues at block 404, where it receives a movement signal indicating movement of a real live entertainment and/or educational professional and/or amateur person and/or other living being and/or their tool(s) during an entertainment or educational or other live event. As an example, the routine may receive input from various sensors proximate to the real live entertainment and/or educational professional and/or amateur person and/or other living being and/or their tool(s), e.g., MEMS sensors, that are broadcast to video game consoles and a part of existing and emerging technological based communication devices such as PDA,s, Tablets Smart Phones, VR Headsets, etc. The routine then continues at block 406, where it receives a control signal from a user using a simulator, e.g., executing at a video game console. As an example, the routine may receive inputs from a game controller that the user employs. The routine then continues at block 408, where it compares the received movement signal to the received control signal. The routine then continues at block 410, where it computes a score and/or a credit based on the comparison. The routine then continues at block 412, where it awards the computed score and/or credit to the user. The routine then continues at block 414, where it activates a motion simulator. The routine then continues at block 416, where it returns.

Those skilled in the art will appreciate that the logic illustrated in FIG. 1 and described above, and in each of the flow diagrams discussed below, may be altered in a variety of ways. For example, the order of the logic may be rearranged, sublogic may be performed in parallel, illustrated logic may be omitted, other logic may be included, etc. In various embodiments, portions of the routine may be executed by a server computing device, a client computing device, or other computing devices.

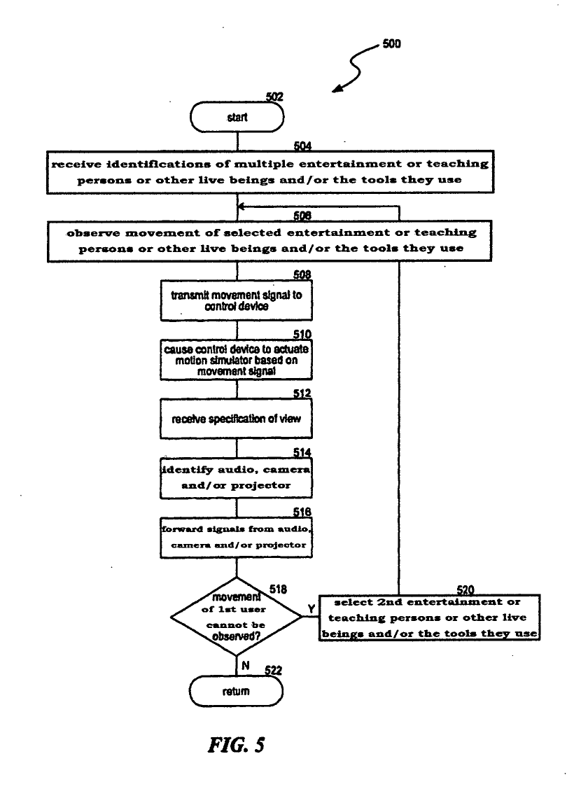

FIG. 5 is a flow diagram illustrating a routine 500 that the technology may invoke in various embodiments, e.g., to enable a video game player to experience (e.g., view, hear, feel, smell, taste, etc.) what a real live entertainment and/or educational professional and/or amateur person and/or other living being and/or their tool(s) does and/or experiences. The routine begins at block 502. The routine then continues at block 504, where it receives identifications of real live entertainment and/or educational professional and/or amateur person and/or other living being and/or their tool(s) and a selection of a first real live entertainment and/or educational professional and/or amateur person and/or other living being and/or their tool(s). In various embodiments, the technology can enable a user to specify one, two, or more real live entertainment and/or educational professional and/or amateur persons and/or other living beings and/or their tool(s). The routine then continues at block 506, where it observes movement (e.g., inputs) of the selected real live entertainment and/or educational professional and/or amateur person and/or other living being and/or their tool(s). The routine then continues at block 508, where it transmits the observed movement signals to a control device proximate to the real live entertainment and/or educational professional and/or amateur person and/or other living being and/or their tool(s). As an example, a guitar or laser scalpel may include a component that collects and broadcasts input received from MEMS sensors, GPS, etc. As another example, a musical concert or surgical educational event may include sensors along stage and gurney edges, musical and surgical instruments and stages and operating theaters, and a transmitter or radio frequency identification chip embedded in a musical and/or surgical instrument. The technology disclosed is best suited to those activities that require the user to remain relatively static in their user environment. E.g., sitting, standing, moving somewhat gently from side to side and back and forth in a limited area but is in no way limited to such movement. The routine then continues at block 510, where it causes the control device to actuate a motion simulator based on the transmitted movement signal. As an example, a full motion simulator employed by a user may simulate motions, sounds, sights, smells, etc. The routine then continues at block 512, where it receives a specification of a view. As an example, the routine may receive an indication of a forward view, a reverse view, a side view, an Omni-directional view, etc. The routine then continues at block 514, where it identifies a camera that is capable of providing the specified view. The routine then continues at block 516, where it forwards signals from the identified camera, e.g., to the game console that the user is using. The routine then continues at decision block 518, where it determines whether the movement signal for the first real live entertainment and/or educational professional and/or amateur person and/or other living being and/or their tool(s) can no longer be observed. As an example, if the real live entertainment and/or educational professional and/or amateur person and/or other living being and/or their tool(s) communications devices become dysfunctional or if the real live entertainment and/or educational professional and/or amateur person and/or other living being and/or their tool(s) live venue has lost power and gone offline, that the real live entertainment and/or educational professional and/or amateur person and/or other living being and/or their tool(s) movement signals may no longer be received. If that is the case, the routine continues at block 520. Otherwise, the routine continues at block 522, where it returns. At block 520, the routine selects the second identified real live entertainment and/or educational professional and/or amateur person and/or other living being and/or their tool(s). The routine then loops to block 506.

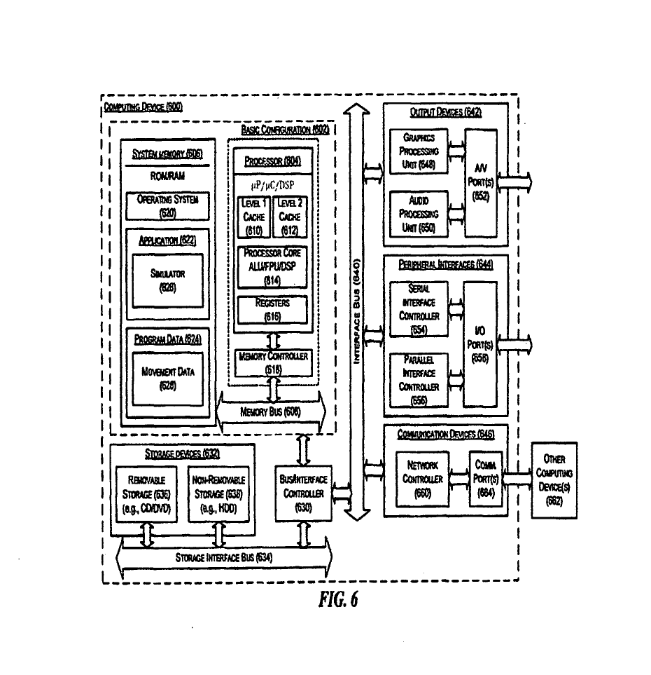

FIG. 6 is a block diagram illustrating an example computing device 600 that is arranged in accordance with at least some embodiments of the present disclosure. In a very basic configuration 602, computing device 600 typically includes one or more processors 604 and a system memory 606. A memory bus 608 may be used for communicating between processor 604 and system memory 606.

Depending on the desired configuration, processor 604 may be of any type including but not limited to a microprocessor (μP), a microcontroller (μC), a digital signal processor (DSP), or any combination thereof. Processor 604 may include one more levels of caching, such as a level one cache 610 and a level two cache 612, a processor core 614, and registers 616. An example processor core 614 may include an arithmetic logic unit (ALU), a floating point unit (FPU), a digital signal processing core (DSP Core), or any combination thereof. An example memory controller 618 may also be used with processor 604, or in some implementations memory controller 618 may be an internal part of processor 604.

Depending on the desired configuration, system memory 606 may be of any type including but not limited to volatile memory (such as RAM), non-volatile memory (such as ROM, flash memory, etc.) or any combination thereof. System memory 606 may include an operating system 620, one or more applications 622, and program data 624. Application 622 may include a simulator component 626 that is arranged to compress data using one or more compression methods. Program data 624 may include movement data 628 (e.g., input data), as is described herein. In some embodiments, application 622 may be arranged to operate with program data 624 on operating system 620 such that rotation of displayed information is enabled or disabled, e.g., depending on an orientation of the display. This described basic configuration 602 is illustrated in FIG. 6 by those components within the inner dashed line.

Computing device 600 may have additional features or functionality, and additional interfaces to facilitate communications between basic configuration 602 and any required devices and interfaces. For example, a bus/interface controller 630 may be used to facilitate communications between basic configuration 602 and one or more data storage devices 632 via a storage interface bus 634. Data storage devices 632 may be removable storage devices 636, non-removable storage devices 638, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape and flash drives to name a few. Example computer storage media may include volatile and nonvolatile, removable and non-removable media implemented in any method or technology for storage of information, such as computer readable instructions, data structures, program modules, or other data.

System memory 606, removable storage devices 636 and non-removable storage devices 638 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage, flash memory drives or other magnetic storage devices, or any other medium which may be used to store the desired information and which may be accessed by computing device 600. Any such computer storage media may be part of computing device 600.

Computing device 600 may also include an interface bus 640 for facilitating communication from various interface devices (e.g., output devices 642, peripheral interfaces 644, and communication devices 646) to basic configuration 602 via bus/interface controller 630. Example output devices 642 include a graphics processing unit 648 and an audio processing unit 650, which may be configured to communicate to various external devices such as a display or speakers via one or more A/V ports 652. Example peripheral interfaces 644 include a serial interface controller 654 or a parallel interface controller 656, which may be configured to communicate with external devices such as input devices (e.g., keyboard, mouse, pen, voice input device, touch input device, video input, sensory input, etc.) or other peripheral devices (e.g., printer, scanner, projector, etc.) via one or more I/O ports 658. An example communication device 646 includes a network controller 660, which may be arranged to facilitate communications with one or more other computing devices 662 over a traditional television or Internet network communication link via one or more communication ports 664.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR), Wi-Fi and other wireless media. The term computer readable media as used herein may include both storage media and communication media.

Computing device 600 may be implemented as a portion of a small-form factor portable (or mobile) electronic device such as a cell phone, a personal data assistant (PDA), a personal media player device, a wireless web-watch device, a personal headset device, an application specific device, a virtual reality device, an augmented reality device, a holographic send and receive device or a hybrid device that include any of the above functions. Computing device 600 may also be implemented as a personal computer including both laptop computer and non-laptop computer configuration.

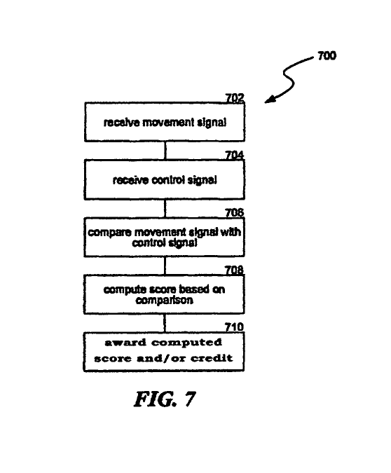

FIG. 7 is a flow diagram illustrating a routine the technology may invoke in various embodiments the technology performs a method 700 comprising: receiving 702 from a remote device a movement signal indicating an actual movement of a real live entertainment and/or educational professional and/or amateur person and/or other living being and/or their tool(s) communications devices a real live event in which the real live entertainment and/or educational professional and/or amateur person and/or other living being and/or their tool(s) communications devices is participating; receiving 704 from a local control device a control signal from a user, wherein the control signal indicates input to a simulation; comparing 706 the received movement signal with the received control signal; computing 708 based on the comparison a score to award to the user, and awarding 710 the computed score to the user. The method can further comprise comparing the awarded score to a set of scores awarded to other users. The method can further comprise receiving an indication to provide a view in a specified direction; transmitting an indication of the specified direction; and receiving a video sequence wherein the video sequence is representative of a view in the specified direction in relation to the real live entertainment and/or educational professional and/or amateur person and/or other living being and/or their tool(s) communications devices. The video sequence may be received from one of multiple remote video cameras located proximate or affixed to the real live entertainment and/or educational professional and/or amateur person and/or other living being and/or their tool(s) communications devices. The technology may receive, record, and/or playback various sounds, e.g., ambient noise, speech, sounds, etc. The method can further comprise receiving movement signals in three dimensions. The method can further comprise receiving control signals in at least two dimensions. The method can further comprise simulating via a motion simulator movement based on the received control signals. The method can further comprise simulating via a motion simulator movement based on the received movement signal. The method can further comprise displaying on one or more panoramic images proximate to the user a view observed by one or more cameras proximate to the real live entertainment and/or educational professional and/or amateur person and/or other living being and/or their tool(s) communications devices.

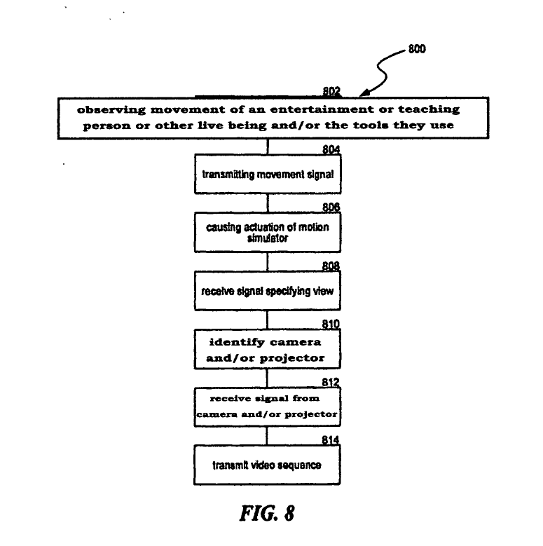

FIG. 8 is a flow diagram illustrating a routine the technology may invoke in various embodiments the technology includes one or more computer-readable storage devices storing instructions, the instructions comprising: observing 802 movement of a first real live entertainment and/or educational professional and/or amateur person and/or other living being and/or their tool(s) during a real live entertainment and or educational event in which the first real live entertainment and/or educational professional and/or amateur person and/or other living being and/or their tool(s) is participating; transmitting 804 to a control device remote from the real live entertainment and or educational event a movement signal indicating the observed movement; and causing 806 the control device to actuate a motion simulator based on the movement signal. The instructions can further comprise: receiving 888 from the control device a signal specifying a view; identifying 810 a camera for the specified view: receiving 812 a signal from the identified camera; and transmitting 814 a video sequence to the control device based on the received signal from the identified camera. The instructions can further comprise broadcasting input signals from the video game player to the location proximate of the real live entertainment and/or educational professional and/or amateur person and/or other living being and/or their tool(s). The instructions can further comprise: receiving identifications of two or more real live entertainment and/or educational professional and/or amateur person and/or other living being and/or their tool(s); if movement of the first real live entertainment and/or educational professional and/or amateur person and/or other living being and/or their tool(s) cannot be observed during the real live entertainment and educational event, selecting a second real live entertainment and/or educational professional and/or amateur person and/or other living being and/or their tool(s) during the real live entertainment and educational event; ceasing transmission of movement signals indicating observed movements of the first real live entertainment and/or educational professional and/or amateur person and/or other living being and/or their tool(s): and automatically starting transmission of movement signals indicating observed movements of the second real live entertainment and/or educational professional and/or amateur person and/or other living being and/or their tool(s).

From the foregoing, it will be appreciated that various embodiments of the present disclosure have been described herein for purposes of illustration, and that various modifications may be made without departing from the scope of the present disclosure. Accordingly, the various embodiments disclosed herein are not intended to be limiting, with the true scope being indicated by the following claims.

I claim:

1. A method performed by a computing system having a processor and memory, comprising:
receiving from a remote device a movement signal indicating an actual movement of an entertainment or teaching person or other live being and/or their tool(s) during a real live entertainment and/or educational event and/or specialized live global event in which the entertainment or teaching person or other live being and/or their tool(s) is participating;
receiving from a local control device a control signal from a user, wherein the control signal indicates input to a simulation;
comparing the received movement signal with the received control signal;
computing based on the comparison a score and/or a credit to award to the user; and
awarding the computed score and/or a credit to the user.

2. The method of claim 1 further comprising comparing the awarded a score and/or a credit to a set of scores and/or credits awarded to other users and to the real live entertainment and/or educational professional and/or amateur person and/or other living being and/or their tool(s).

3. The method of claim 1 further comprising: receiving an indication to provide a view in a specified direction; and transmitting an indication of the specified direction; and receiving a video and/or audio and/or other sensory input sequence wherein the video and/or audio and/or other sensory input sequence is representative of a view in the specified direction in relation to the real live entertainment and/or educational professional and/or amateur person and/or other living being and/or their tool(s).

4. The method of claim 3, wherein the video and/or audio and/or other sensory input sequence is received from one of multiple remote video cameras: and microphones and/or other sensory input devices located proximate or affixed to the real live entertainment and/or educational professional and/or amateur person and/or other living being and/or their tool(s).

5. The method of claim 1 further comprising receiving movement signals in three or more dimensions.

6. The method of claim 5 further comprising receiving control signals in at least two dimensions.

7. The method of claim 6 further comprising simulating via a motion simulator, movement based on the received control signals.

8. The method of claim 1 further comprising simulating via a motion simulator movement based on the received movement signal.

9. The method of claim 1 further comprising displaying on one or more panoramic images proximate or attached to the user a view observed by one or more cameras proximate to the real live entertainment and/or educational professional and/or amateur person and/or other living being and/or their tool(s).

10. A system, comprising: a remote system, proximate to a real live entertainment and/or educational professional and/or amateur person and/or other living being and/or their tool(s) participating in a real entertainment and/or educational or other specialized live event, configured to observe inputs provided by the real live entertainment and/or educational professionals and/or amateur persons and/or other living beings and/or their tool(s) indicative of a desired movement, and/or actual movements or activities of the real live entertainment and/or educational professional and/or amateur person and/or other living being and/or their tool(s); to receive signals from one or more cameras and to display output signals from one or more projectors; and
to transmit indications of the observations as movement signals; and
to transmit a video sequence based on the signals received from at least one of the cameras; and
microphones and/or other sensory I/O devices; and a local system, proximate or affixed to a user participating in a simulation of the real live entertainment or educational event, configured to receive inputs and outputs from the user the real live entertainment and/or educational professional and/or amateur person and/or other living being and/or their tool(s); and
compare the inputs and outputs received from the user the real live entertainment and/or educational professional and/or amateur person and/or other living being and/or their tool(s) with received movement signals; and
compute based on the comparison a score and/or a credit to award to the user; the real live entertainment and/or educational professional and/or amateur person and/or other living being and/or their tool(s); and
create a hybrid environment between standard television broadcasting and digital and analogue video game online signals to create an autonomous hybrid of simulations and live action video that enables simulations to be greatly enhanced, augmented and directly integrated into live and recorded live fully immersive broadcast events: and
enables users to interact with standard television broadcast using their simulated avatars and/or real world live representations to display and interact with in real-time and/or recorded live action events using their display and controller method and mechanisms of choice: and
to stream live user created video, audio, sensory and holographic projections and interject this live hybrid broadcast stream into the live environment occupied by the real live entertainment and/or educational professional and/or amateur person and/or other living being and/or their tools and online collaborators and competitors and/or their tool(s).

11. The system of claim 10 further comprising a component configured to award the computed score and/or a credit to the user.

12. The system of claim 11 further comprising an electronic game and an educational fully interactive training tool format.

13. The system of claim 10 wherein the remote system comprises one or more microelectromechanical systems (MEMS) sensors to observe movement of the real live entertainment and/or educational professional and/or amateur person and/or other living being and/or their tool(s) in multiple directions, wherein each MEMS sensor is configured to detect movement and/or rotation in one or more or all axes.

14. The system of claim 10 wherein the remote system comprises a global positioning system antenna.

15. The system of claim 10 wherein the remote system comprises a radio frequency identification unit.

16. The system of claim 10 wherein the local system comprises a motion simulator.

17. The system of claim 10 wherein the local system comprises a sensory I/O (input-output) mechanism.

18. The system of claim 10 wherein the local system comprises one or more panoramic displays: and one or more virtual and augmented reality mechanisms and/or holographic recording and projections mechanisms and artificial intelligence systems. 19 The system of claim 10 wherein the local system comprises one or more audio sound recording and playback I/O mechanisms.

20. A computer-readable storage device storing instructions, the instructions comprising:
observing movement of a real live entertainment and/or educational professional and/or amateur person and/or other living being and/or their tool(s) during a real live event in which the first the real live entertainment and/or educational professional and/or amateur person and/or other living being and/or their tool(s) is participating; and
transmitting to a control device remote from the real live entertainment and/or educational event a movement and/or audio sound and/or sensory signal indicating the observed movement and/or relevant sound and/or sensory perception; and
causing the control device to actuate a motion simulator based on the movement and/or audio signal and/or sensory signal.

21. The computer-readable storage device of claim 18 further comprising:
receiving from the control device a signal specifying a view;
identifying a camera for the specified view; and
receiving a signal from the identified camera; and
transmitting a video sequence to the control device based on the received signal from the identified camera.

22. The computer-readable storage device of claim 18 further comprising:
receiving from the video game player and/or remote user and/or the real live entertainment and/or educational professional and/or amateur person and/or other living being and/or their tool(s) signal specifying a view; identifying a camera for the specified view; and
receiving a signal from the identified camera; and using a projector proximate to the video game player and/or remote user and/or the entertainment or teaching person or other live being and/or their tool(s) transmitting a projected video sequence to the control device based on the received signal from the identified camera.

23. The computer-readable storage device of claim 18 further comprising:
receiving identifications of two or more video game players and/or remote users and/or the real live entertainment and/or educational professional and/or amateur person and/or other living being and/or their tool(s); and
if movement of the first the real live entertainment and/or educational professional and/or amateur person and/or other living being and/or their tool(s) cannot be observed during the real live entertainment and/or educational event, selecting an alternative real live entertainment and/or educational professional and/or amateur person and/or other living being and/or their tool(s) during the real live entertainment and/or educational event;
ceasing transmission of movement signals indicating observed movements of the first real live entertainment and/or educational professional and/or amateur person and/or other living being and/or their tool(s); and
automatically starting transmission of movement signals indicating observed movements of the second, third or fourth, and so on, real live entertainment and/or educational professional and/or amateur person and/or other living being and/or their tool(s).
